(19) United States
(12) Patent Application Publication
(10) Pub. No.: US 2006/0006023 A1
(43) Pub. Date: Jan. 12, 2006

(54) Combination rear impact guard, ladder, and ramp for military cargo vehicles

(75) Inventor: James G. Lim, Macomb, MI (US)

Correspondence Address: U.S. ARMY TACOM;ATTN: AMSTA-LP/281, 6501 E. 11 MILE RD., WARREN, MI, 48397-5000, US

(73) Assignee: The United States of America as represented by Secretary of the Army, Washington, DC (US)

(21) Appl. No.: 10/890,840

(22) Filed: Jul. 8, 2004

(51) Int. Cl. E06C 5/00

(52) U.S. Cl. 182/127

(57) ABSTRACT

There is described and claimed herein a multifunctional rear impact guard, step ladder, and cargo ramp structure suitable for positioning across a rear bead of a military cargo vehicle to provide the three separate functions as mentioned above. In the retracted position, this structure functions as a rear impact guard, vertically positioned about 1.5 to 2.0 feet above the ground surface to prevent motor vehicles from passing below a cargo bearing bed and impacting the rear wheels or running assembly. When deployed at a 30°0 to 50° angle from the ground surface, the structure provides horizontal steps, with an optional handrail, for ingress or egress by troops. As further deployed at approximately the same angle, the structure forms a continuous cargo ramp for loading or unloading operations of goods and cargo.

### GOVERNMENT INTEREST

The invention described herein may be made, used, and licensed by, or for, the United States Government for governmental purposes without paying me any royalty.

### BACKGROUND AND SUMMARY

This invention relates to a multifunctional structure to be vertically mounted on the rear of military cargo vehicles, such as tactical trucks, trailers, and semi-trailers. In a first aspect, the invention in a retracted or closed position acts as a rear-impact guard to avoid rear-end crashes by trailing motor vehicles with the bed, its underside, and/or the running gear. In another aspect, the same structure when partially extended will give soldiers a ladder structure to facilitate their ingress and egress of the rear bed. In a separate aspect, a ramp is easily provided when said structure is fully extended to load and unload cargo aboard the vehicle.

Thus, military cargo vehicles are used by armed forces for the transport over long distances of heavy military equipment, ammunition, fuels, water, rations, troops, and related support cargos within a theater of operations. These activities often require a variety of both medium- and heavy-duty vehicles that operate within less than optimal environments, including on- and off-road conditions, for support of our global peacekeeping and warfighting efforts.

As used herein, a typical cargo vehicle is chosen from a Family of Medium Tactical Vehicles (FMTVs), that are produced by Stewart & Stevenson of Houston, Tex., USA. These trucks are available in a number of variants with load capabilities ranging between 2.5 to 10 tons. The subject trucks and trailers may, or may not, have tailgates or doors across the horizontal rear end of the bed. These gates and doors may be fashioned of a hard material or they may be made in the form of a web of natural or synthetic fibers and coatings or composites thereof.

It is understood that the readiness requirements for these vehicles are highly unusual, and therefore necessitate more rigorous and reliable designs than their commercial counterparts. The components of these vehicles, including the bed, supporting elements, and associated equipment, must tolerate more frequent vibrations and impacts than their commercial counterparts. These requirements are even greater when military personnel are aboard.

Normally, the beds of cargo vehicles are disposed some vertical distance, typically up to about 5 feet, above the surface over which they are traveling. The result of this configuration is that the beds are substantially horizontal and overhang the running gear or wheels by a considerable distance. For over the road applications, this high vertical alignment can present potential problems for any trailing vehicle of lower height than the bed overhang. Since an operator of a trailing vehicle may become distracted while driving, it is possible that the trailing vehicle might strike the cargo vehicle and submarine below the bed. Reference is made to FIGS. 1 and 2 for clearer understanding of this potential.

The likely result of such an accident would be sustainment of substantial damages and injuries to both passengers and vehicles. As used herein, a trailing vehicle includes trucks, cars, vans, and sport utility vehicles of a variety of shapes and sizes. As a result, it is very desirable to equip our military cargo vehicles with rear impact protection, or under-ride prevention, for highway travel. Moreover, a host of motor carrier safety standards have been set by state and federal regulatory agencies to mandate the addition of protective devices for trucks and trailers to avoid or ameliorate the potential for accidents. See, for example, 49 Code of Federal Regulations 571.223 and .224.

Moreover, the bed height of military cargo vehicles makes it quite difficult for a soldier to enter or embark from the elongated, horizontal bed without some means of assistance. This problem is further compounded by the fact that soldiers must carry battle gear on them which can weigh somewhere in the neighborhood of 60 to 100 pounds. This gear is also quite bulky and is rarely distributed evenly about the body. These factors negatively affect balance and place the solider at substantial risk during entry or exit of a vehicle bed without a more practical form of support and assistance.

These and other objects, features, and advantages of this invention will be apparent to those skilled in the relevant arts upon a full reading of this specification and the appended claims which explain and define the aspects and principals of this invention.

### BRIEF DESCRIPTION OF THE DRAWINGS

FIG. 1 is a fragmentary rear view of a military cargo vehicle of the prior art.

FIG. 2 is a side view of the vehicle of FIG. 1.

FIG. 3 is a side view of a military cargo vehicle with my invention installed in a retracted position as a rear impact guard that horizontally extends across the rear end.

FIG. 4 is a separate side view depiction of my invention secured across a rear bed of a military cargo vehicle and deployed therein as a set of supporting stairs for troop exit or entry of said vehicle.

FIG. 5 is another side view of my invention where it is mounted across a rear bed of a military cargo vehicle as a platform and/or ramp to accomplish loading and unloading operations.

### DETAILED DESCRIPTION

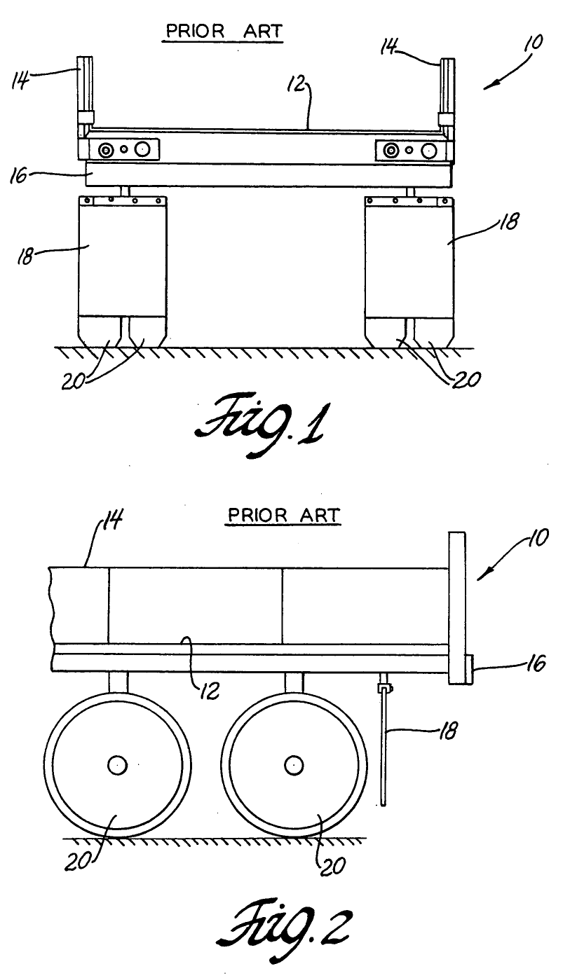

FIG. 1 depicts a military cargo vehicle 10 of the prior art in fragmentary rear view. It is to be understood that our military interchangeably uses a variety of trucks and trailers for the purposes of supporting units that are engaged in a variety of war fighting or peacekeeping operations. Cargo vehicles have highly unusual usage requirements for the rapid deployment of troops and cargo over both paved and/or cross country routes. The subject vehicle has a bed 12 resting on a chassis 16 and vertical side-rails or side-walls 14 that extend upwardly from each side of the vehicle bed. Mudflaps 18 and wheels 20 of a conventional nature are shown therein below said bed.

Although not shown in this figure, a conforming rail or wall is also transversely provided across the front of the bed to afford troop safety and cargo retention. A rear tail gate may, or may not, also be provided. If it is, it will be an elongated rectangle in form and made of a hard material or an open mesh net with reinforcement. Either form of the tailgate will have conforming receptors thereon that will couple with compatible receptors on the side rails. Examples of intended hard materials are selectable from the group consisting essentially of composite materials, aluminum, and alloys of iron. Mesh nets are usually made of natural and/or synthetic fibers that can be further reinforced or impregnated with compatible rubbers, silicones, plastics, and synthetic polymers to further enhance strength.

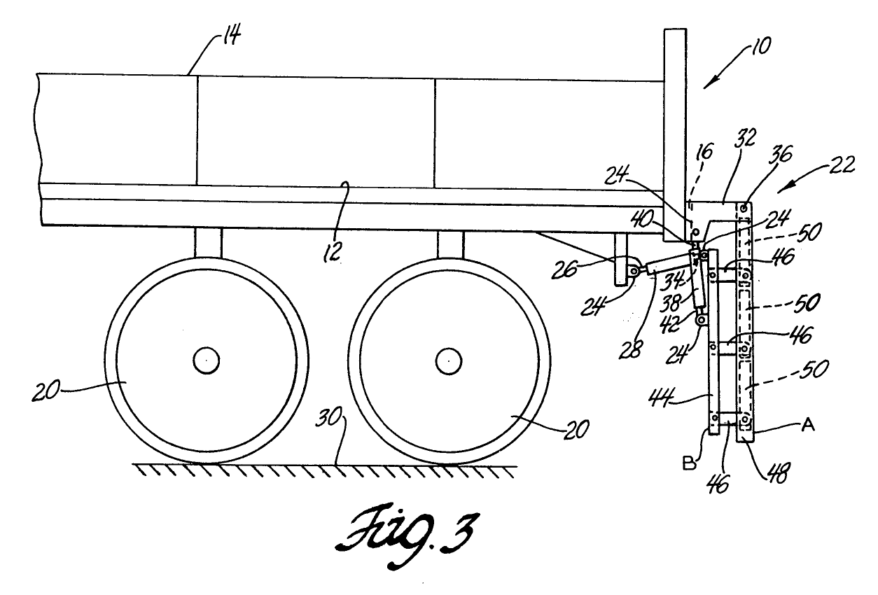

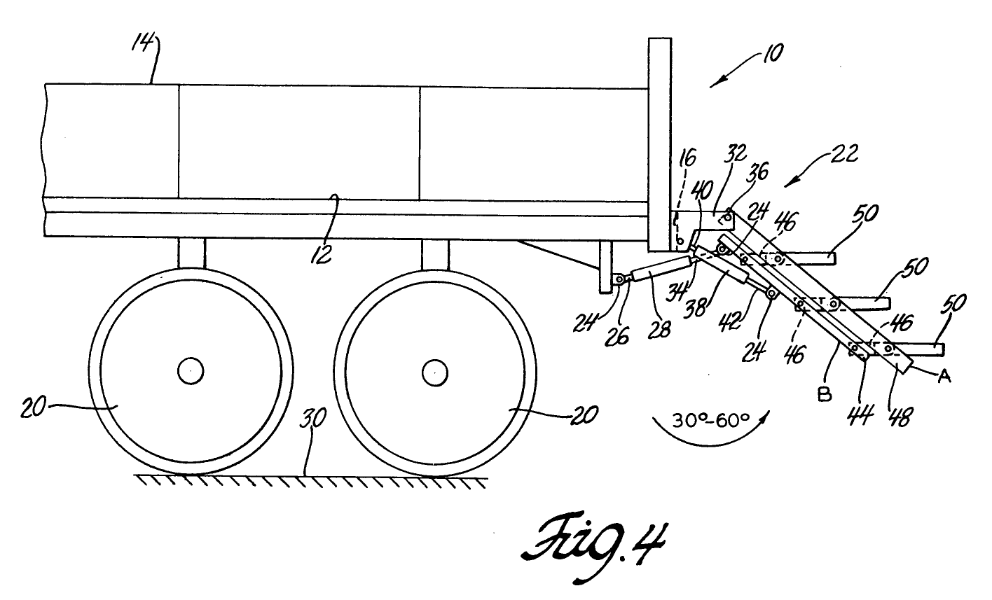

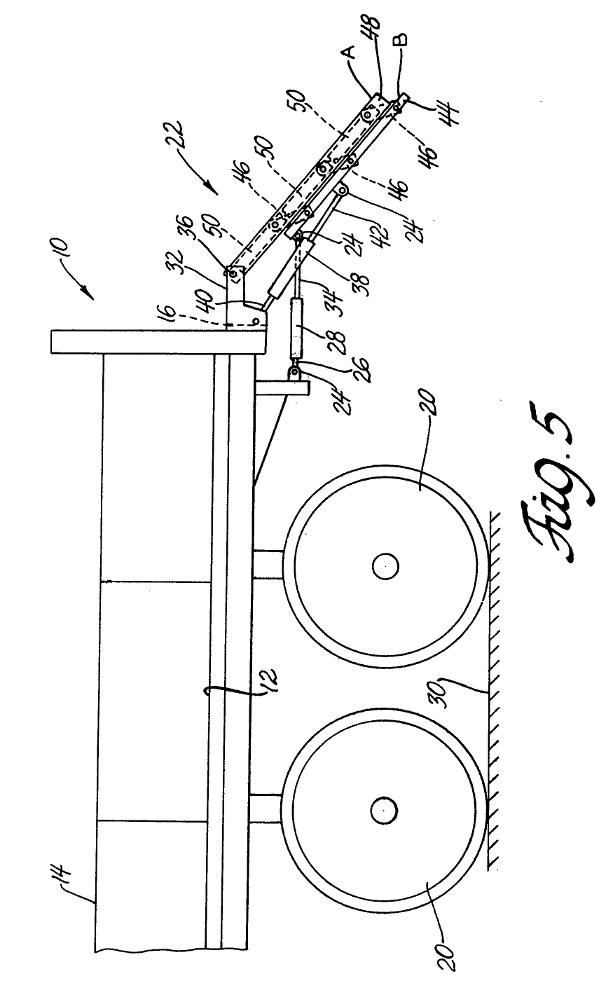

FIG. 2 is a side view of the cargo vehicle 10 of FIG. 1 further depicting the extent of overhang between the wheels 20 and the rear of the bed 12. Absent a rear impact guard, this overhang represents a significant hazard to trailing motor vehicles. In a typical operation cycle, the multifunctional structure 22 predominately remains in a retracted position and functions, under Federal Highway Safety Standards, as a rear impact guard according to FIG. 3. Occasionally, this structure will be swept away from the vertical position of FIG. 3 and into the position of a step ladder as shown in FIG. 4 to allow troop egress or ingress to the vehicle bed. When a need arises for a cargo platform or ramp, then either version of my structure, as shown in FIGS. 3 and 4, can be further extended into the requisite configuration. Finally, the structure 22 is normally returned to a vertical position that downwardly extends to about 1.5 to 2.0 feet from the ground surface 30 once loading/unloading operations have ceased. This particular form of the invention 22 makes an efficient rear impact guard.

As shown in FIG. 3, the described hazard of FIG. 2 is surprisingly reduced by the structure of the claimed invention 22. In FIG. 3, the structure 22 is mounted to the chassis 16 at the rear of the vehicle by a joining interconnection of a receiving means 24 on said vehicle and interface assembly means 32 on the top of structure 22. Suitable materials for compatible receiving means herein include items selectable from a group consisting essentially of a mounting lunette, clevis, pivot, flange, fork, lug, bracket, eyelet, yoke, rivet, weldment, and threaded fastener. The exact selection of which is a matter of availability to the installer, or which will be determined by a cost engineering evaluation during a commercial design and analysis for the production of commercial quantities.

Receiving means 24 is multifunctional and can be used for making connections with inward and outward rams 26 and 34, respectively, of a first actuator means 28 that appears as substantially horizontal in FIG. 3 for the rear impact guard configuration. Second actuator means 38, having upper and lower rams 40 and 42, respectively, are nearly vertically positioned in the rear impact guard configuration with these opposing rams connecting to like receiving means 24 located on the interface assembly means 32 and on a second parallel support means 44, respectively. The second parallel support means 44 has at least six (three?) pivotal connections, equally spaced apart, that in turn connect to at least three (six?) articulating links 46 that are in mechanical translation with a first parallel support means 48 about a like number (3) of pivotal connections.

It will be understood, therefore, that the first and second parallel support means are equally spaced apart at all times due to the rotation or shifting of step means 50 from the vertical to horizontal to angular positions given angular movement of structure 22 from rear impact guard, to step ladder, and then cargo ramp as respectively shown by FIGS. 3, 4, and 5. Since the rails, A and B, respectively, of the first 48 and second 44 parallel support means are also pivotally coupled to the step means 50, said rails are also dimensionally spaced apart as a continuous parallelogram.

FIG. 4 depicts the present invention deployed as a step ladder for mounting and debarking the bed by troops. In this configuration, the first actuator means 28 has further extended inward ram 26 and outward ram 34 to produce an angular sweep away from the vehicle bed to create an angle of about 30° to 60° between said bed 12 and the ground surface 30. As this occurs, the structure 22 rotates outwardly from the bed of vehicle 10 about a first pivotal connection 36 on interface assembly 32. This movement causes extension of the first and second parallel support means as a second substantially horizontal actuator moves outward from the rear bed of the vehicle 10.

I wish it understood that I do not desire to be limited to the exact details of construction or method shown herein since obvious modifications will occur to those skilled in the relevant arts without departing from the spirit and scope of the following claims.

1. In combination a rear impact safety guard, step ladder, and cargo ramp structure comprising:
a. a first parallel support means having a pair of equally spaced apart rails, separated by at least three vertical pivotal step means, that are initially deployed in a vertical position as a rear impact safety guard, said first parallel support means being suspended by a set of corresponding bores positioned at each rail top and then secured within a mounting boss and held therein by insertion of a rotatable axle that passes through said bores and into said boss, thereby the structure extends vertically downward to about 18 to 24 inches from ground surface, said structure substantially extending across a rear bed of a military cargo vehicle from outer wheel to outer wheel of a pair of dual wheels located on each side of the vehicle;
b. a second parallel support means also having a pair of equally spaced apart rails and interlinked to said first parallel support means by a plurality of rotatable linkage means that move about a plurality of pivotal connections equally divided and spaced apart on both first and second parallel support means to continuously maintain said first and second parallel support means spaced apart as said structure is angularly swept outward from said vehicle rear by an essentially horizontal first actuator means that is mounted between a receiving means on the vehicle bed and a receiving means on the first parallel support means, coupled almost simultaneously with operation of an essentially vertical second actuator means, similarly mounted between receiving means on said mounting boss and receiving means on second parallel support means, to form a deployed step ladder for troops between said vehicle bed and the ground having substantially parallel steps that are essentially horizontal to ground with said first and second parallel support means at an angle of about 30° to 50° from said ground; and
c. if a ramp means is needed for the vehicle, first and second actuator means are used to deploy said structure as a cargo ramp by angularly sweeping said structure away from the vehicle bed sufficient to cause said rotatable linkage means and said step means to further rotate about a plurality of pivotal connections to form said ramp means at an angle of about 30° to 50° with the ground surface:

2. The combination structure of claim 1 wherein said structure is made of a hard material.

3. The combination structure of claim 2 wherein the hard material is selected from the group consisting essentially of composite materials, alloys of iron, and aluminum.

4. The combination structure of claim 3 wherein said structure is formed by conventional metal working techniques.

5. The combination structure of claim 4 wherein the metal working techniques are selected from the group essentially consisting of casting, cutting, machining, welding, stamping, and punching.

6. The combination structure of claim 5 wherein said military cargo vehicle is a military tactical truck.

7. The combination structure of claim 6 wherein said cargo vehicle is a trailer.

8. The combination structure of claim 1 including a removable hand rail.

9. The combination structure of claim 1 including a tailgate.

10. The combination structure of claim 9 wherein the tailgate is made of a hard material.

11. The combination structure of claim 9 wherein the tailgate is made of a mesh net material.

12. The combination structure of claim 11 wherein the mesh net is made of natural fibers and synthetic polymers.

13. The combination structure of claim 12 wherein the natural and synthetic fibers are reinforced by compatible rubbers, silicones, plastics, and like materials to enhance strength.

14. The combination structure of claim 11 wherein the receiving means is selected from the group consisting essentially of a mounting lunette, clevis, pivot, flange, fork, lug, bracket, eyelet, yoke, rivet, weldment, and threaded fastener.

15. The combination structure of claim 1 wherein the mounting boss is selected from the group consisting essentially of a mounting lunette, clevis, pivot, flange, fork, lug, bracket, eyelet, yoke, rivet, weldment, and threaded fastener.
